(19) United States
(12) Patent Application Publication
(10) Pub. No.: US 2003/0038195 A1
(43) Pub. Date: Feb. 27, 2003

(54) Rasp carrier

(76) Inventors: Richard David Blair Coburn, Ottawa (CA); Abdul Aziz, Kanata (CA); Michael T. O' Malley, Appleton (CA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/940,339

(22) Filed: Aug. 27, 2001

(51) Int. Cl. B02B 1/00

(52) U.S. Cl. 241/30

(57) ABSTRACT

A carrier for a rasp that serves to support the rasp when it is in use and store the rasp when it is not being used. The rasp carrier includes a bottom, two side walls, a back wall, and a tab positioned on the back wall. To support the rasp, the rasp is positioned atop the carrier. The side edges of the rasp fit over the side walls of the carrier to prevent lateral movement of the rasp relative to the carrier. A mounting hole on the rasp engages the tab on the rasp carrier to prevent linear movement of the rasp along the carrier. To store the rasp, the rasp is removed from the top of the carrier and slid between the side walls of the carrier.

### FIELD OF THE INVENTION

This invention relates to a support and storage carrier for a rasp for use in grating food.

### BACKGROUND OF THE INVENTION

Rasps are used in a variety of applications to grate or shave objects. Most commonly, rasps are used in woodworking to shape wood. Similar devices are also used in cooking applications to grate foods, such as vegetables and cheese. Microplane® wood rasps, described in U.S. Pat. No. 5,100,506, are particularly good for grating fruits, vegetables, and cheese. Microplane® rasps and some other food graters are generally a piece of thin stamped metal having passages through the metal and cutting edges projecting from the rasp adjacent the passages. In use, the user holds the rasp and, while applying pressure, moves the object along the length of the rasp so that the object engages the projecting cutting edges. Alternatively, the rasp may be moved against a stationery object. The cutting edges grate or strip slivers from the object and force the slivers through the passages in the rasp. Thus, the object engaging one side of the rasp emerges as grated slivers or particles from the other side of the rasp.

A rasp can be cumbersome, fatiguing, and dangerous to use with food. The user must hold the object and the rasp at the same time, while positioning the rasp so that the resulting grated particles are directed into the desired container. Moreover, to grate some foods, the user must apply a significant amount of pressure while moving the object along the rasp, making it painful at times. Should the users hand slip during use, the cutting edges can scrape and injure the user's hand, especially the knuckles. To stabilize the rasp, the user generally positions one end of the rasp against a stable surface. However, because the rasp is not designed to lockingly engage the surface and oftentimes significant pressure is being applied to the rasp at an angle to the surface, the rasp may slide across the surface, which can also lead to injury.

### SUMMARY OF THE INVENTION

This invention addresses these problems by providing a carrier for a rasp that serves to support the rasp when it is in use and store the rasp when it is not being used. The rasp carrier includes a bottom, two side walls, a back wall, and a tab positioned on the back wall. To support the rasp in use, the rasp is positioned atop the carrier. The side edges of the rasp fit over the side walls of the carrier to prevent lateral movement of the rasp relative to the carrier. A mounting hole on the rasp engages the tab on the rasp carrier to prevent linear movement of the rasp along the carrier. To store the rasp, the rasp is removed from the top of the carrier and slid between its side walls.

The rasp carrier obviates the need for the user to support and position the rasp. Moreover, when the user moves the object along the rasp, the rasp cannot move relative to the carrier (either linearly or laterally) under the pressure and therefore the likelihood of the rasp slipping and injuring the user is greatly reduced. The carrier also provides resistance against the pressure applied to the rasp by the user, thereby decreasing the amount of pressure that must be applied. Significantly, when the rasp is positioned on the carrier, the carrier provides a collection area for the shavings. The shavings can then be poured out of the open end of the carrier and into another container for use.

It is an object of this invention to provide a support for a rasp in use to facilitate use of the rasp and prevent injury to the user.

It is also an object of this invention to provide a collection container for food slivers removed by the rasp.

It is another object of the present invention to provide a storage container for a rasp to protect the user against the cutting edges of the rasp as well as prevent damage to the cutting edges.

### BRIEF DESCRIPTION OF THE DRAWINGS

FIG. 1 is a perspective view of one embodiment of the rasp carrier of the present invention.

FIG. 2 is a side elevation view of the rasp carrier of FIG. 1.

FIG. 3 is a front elevation view of the rasp carrier of FIG. 1.

FIG. 4 is a back elevation view of the rasp carrier of FIG. 1.

FIG. 5 is a top plan view of the rasp carrier of FIG. 1.

FIG. 6 is a bottom plan view of the of the rasp carrier of FIG. 1.

FIG. 7 is the perspective view of the rasp carrier of FIG. 1 showing a rasp positioned on the carrier.

FIG. 8 is a perspective view of an alternative embodiment of the rasp carrier of the present invention.

### DETAILED DESCRIPTION OF THE DRAWINGS

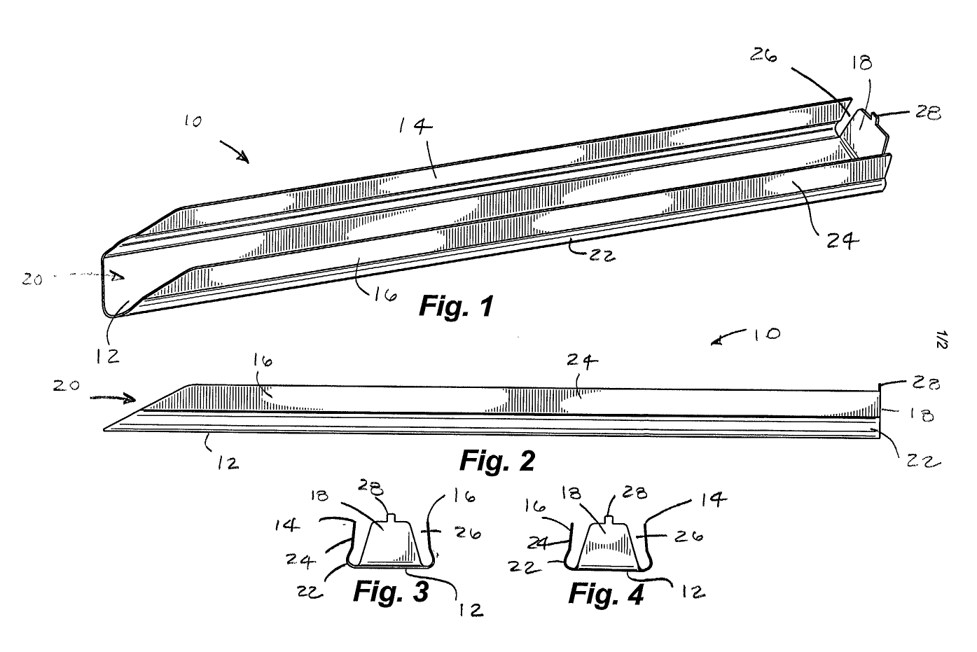

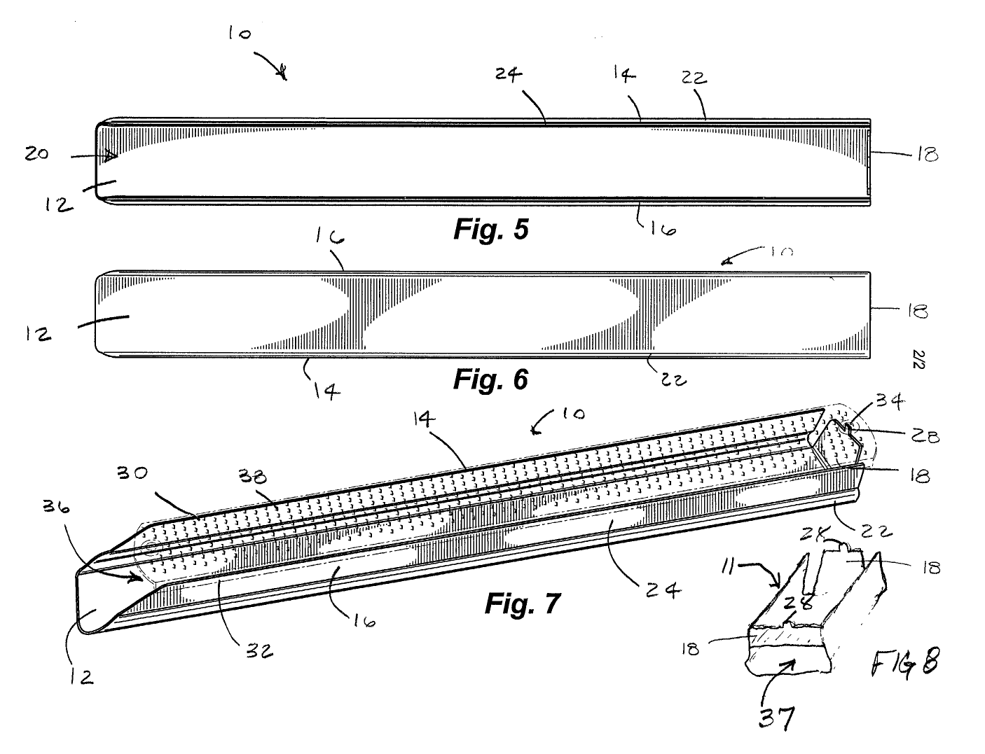

FIGS. 1-7 illustrate one embodiment of the rasp carrier 10 of the present invention. The rasp carrier 10 includes a bottom 12, two side walls 14, 16, a back wall 18, and an open mouth 20. One skilled in the art will understand that another wall may be positioned on the carrier end opposite that of the back wall 18 to at least partially seal off the open mouth 20 (see FIG. 8). Also, the rasp carrier 10 illustrated in FIGS. 1-8 is symmetrical along its length, but may be formed of any shape to accommodate a particular rasp. While the rasp carrier 10 may be made from any material having suitable properties, including structural integrity and water resistance, it is preferably made of stainless steel, which maintains its shape under significant force and is rust resistant and dishwasher safe. Moreover, while not required, the walls 14, 16, 18 of the rasp carrier 10 are preferably integrally-formed with the bottom 12, which contributes to the longevity of the carrier 10 and the ease of its manufacture. For example, the rasp carrier 10 may be stamped out of a metal sheet and then bent to form the desired shape.

As best seen in FIGS. 3 and 4, the side walls 14, 16 of the rasp carrier 10 preferably, but do not have to, have a bulbous section 22 located proximal to the bottom 12 and a straight section 24 located distal to the bottom 12. In this embodiment, the distance between the bulbous section 22 of the side walls 14, 16 is greater than the distance between the straight section 24 of the side walls 14, 16. To facilitate cleaning of the rasp carrier 10, an opening 26 is preferably provided between the back wall 18 and each of the side walls 14, 16. In the embodiment of FIGS. 1-7, a tab is positioned on and integrally-formed with the back wall 18. Naturally, the tab 28 may be a separate component and affixed to the carrier 10. More than one tab 28 may be provided on the rasp carrier 10 to enhance its versatility. Additionally, depending on the rasp with which the carrier 10 is intended be used, the tab 28 may be positioned on the side walls 14, 16 as well.

The carrier 10 is designed to support the rasp 30 in use (see FIG. 7) or safely store the rasp 30 when not in use. The exemplary rasp illustrated in FIG. 7 with which carrier 10 may be used is a Microplane® rasp model #30001 having a hole at each end for mounting the rasp in a hacksaw frame. To support the rasp 30, the rasp 30 is positioned atop the carrier 10. The side edges 32 of the rasp 30 fit over the straight section 24 of the side walls 14, 16 to prevent lateral movement of the rasp 30 relative to the carrier 10. The rasp 30, having at least one mounting hole 34, is positioned so that the hole 34 engages the tab 28 on the rasp carrier 10. This interlock between the mounting hole 34 and tab 28 prevents linear movement of the rasp 30 along the carrier 10. The rasp carrier 10 obviates the need for the user to support and position the rasp 30. Moreover, when the user moves the object along the rasp 30, the rasp 30 cannot move (either linearly or laterally) under the pressure and therefore the likelihood of the rasp 30 slipping and injuring the user is greatly reduced. The carrier 10 also provides resistance against the pressure applied to the rasp 30 by the user, thereby decreasing the amount of pressure that must be applied. The structure of the carrier 10 is such that, when the rasp 30 is positioned on the carrier 10, a collection area 36 for the shavings is formed. The shavings can then be easily transferred through the open mouth 20 of the carrier 10 and into another container for use.

The carrier 10 also may be used to store the rasp 30 and thereby reduce the risk of injury to the user. For storage, the rasp 30 is removed from the top of the carrier 10 and slid between the bulbous section 22 of the side walls 14, 16 of the carrier 10. The back wall 18 serves as a stop to prevent the rasp 30 from sliding out of the carrier 10. During storage, the rasp 30 may be positioned with the cutting edges 38 facing up or down. Moreover, the carrier 10 is designed so that, if turned upside down, the straight section 24 of the side walls 14, 16 prevent the stored rasp 30 from falling out of the carrier 10.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims. For instance, the same functional aspects of the carrier 10 can be achieved in a structure having a considerably different appearance and with different components. For example, the carrier 10 might be machined from a block of material rather than formed by bending a sheet, and it might be molded of a suitable plastic material rather than formed of metal. As noted above, it might have a wall 18 and tab 28 on each end of the carrier 10. Either or both of the walls 18 could also join sides 24, 26 if it were desired that carrier 10 provide a closed container into which slivers fall during use. FIG. 8 illustrates one embodiment of such a carrier 11 having tabs 28 on each end and an opening 37 into which the rasp 30 can be inserted for storage.

We claim:

1. A rasp carrier comprising:
a. a bottom;
b. a plurality of walls extending from the bottom including:
i. two side walls, wherein the distance between the side walls is greater at a first position proximal to the bottom than at a second position distal from the bottom; and
ii. a back wall; and
c. means for preventing linear movement of a rasp positioned on the carrier relative to the carrier.

2. The rasp carrier of claim 1, wherein the bottom and plurality of walls are integrally-formed.

3. The rasp carrier of claim 1, wherein the carrier comprises metal.

4. The rasp carrier of claim 1, wherein the means for preventing linear movement comprises at least one tab positioned on at least one of the plurality of walls.

5. The rasp carrier of claim 4, wherein the tab is positioned on the back wall.

6. The rasp carrier of claim 4, wherein the at least one tab is integrally-formed with the at least one of the plurality of walls.

7. The rasp carrier of claim 1, wherein the side walls do not abut the back wall.

8. A rasp system comprising:
a. a rasp having side edges and at least one mounting hole;
b. a rasp carrier comprising:
i. a bottom;
ii. a plurality of walls extending from the bottom including:
(a) two side walls, wherein the distance between the side walls is greater at a first position proximal to the bottom than at a second position distal from the bottom; and
(b) a back wall; and
iii. at least one tab positioned on at least one of the plurality of walls,
wherein the rasp is positionable atop the carrier when the rasp is in use and within the carrier when the rasp is not in use.

9. The rasp system of claim 8, wherein when the rasp is in use, the rasp is placed atop the carrier so that the rasp side edges are positioned at least partially around the carrier side walls and the at least one tab engages the at least one mounting hole of the rasp.

10. The rasp system of claim 8, wherein when the rasp is not in use, the rasp is positioned in the first position between the side walls of the rasp carrier.

11. The rasp system of claim 8, wherein the rasp comprises metal.

12. The rasp system of claim 8, wherein the rasp carrier comprises metal.

13. The rasp system of claim 8, wherein the bottom and the plurality of walls are integrally-formed.

14. The rasp system of claim 8, wherein the tab is integrally-formed with the back wall.

15. A method of using a rasp comprising:
a. positioning a rasp, having side edges, at least one mounting hole, and at least one cutting edge, atop a rasp carrier comprising:
i. a bottom;
ii. a plurality of walls extending from the bottom including:
(a) two side walls, wherein the distance between the side walls is greater at a first position proximal to the bottom than at a second position distal from the bottom; and
(b) a back wall; and
iii. at least one tab positioned on at least one of the plurality of walls,
so that the rasp side edges are positioned at least partially around the carrier side walls and the at least one tab engages the at least one mounting hole of the rasp; and
b. rubbing an object along the rasp to engage the at least one cutting edge to thereby shave at least one piece off of the object.

16. A method of storing a rasp comprising:
a. providing a rasp carrier comprising:
i. a bottom;
ii. a plurality of walls extending from the bottom including:
(a) two side walls, wherein each side wall comprises a bulbous section and a straight section; and
(b) a back wall; and
(c) an open mouth opposite the back wall; and
b. inserting the rasp into the open mouth of the carrier between the bulbous section of the side walls.

17. A rasp carrier, comprising a sheet of stainless steel bent to provide a pair of elongated, generally parallel supports and a tab for engaging a rasp to resist sliding movement of the rasp relative to the carrier.
